(19) United States
(12) Patent Application Publication
(10) Pub. No.: US 2008/0133747 A1
(43) Pub. Date: Jun. 5, 2008

(54) System to self organize and manage computer users

(76) Inventor: Russell H. Fish, Dallas, TX (US)

Correspondence Address: MORGAN LEWIS & BOCKIUS LLP, 1111 PENNSYLVANIA AVENUE NW, WASHINGTON, DC, 20004, US

(21) Appl. No.: 11/986,199

(22) Filed: Nov. 20, 2007

Related U.S. Application Data
(60) Provisional application No. 60/860,342, filed on Nov. 21, 2006.

(51) Int. Cl. G06F 15/173

(52) U.S. Cl. 709/224

(57) ABSTRACT

In one aspect, the invention comprises a system for a networked community comprising: a verification component operable to verify each of a plurality of cyberidentities, a first computer memory operable to store information related to the interaction of each of said plurality of cyberidentities within said networked community; and a transparency component operable to allow said plurality of cyberidentities to access at least part of said stored information. In another aspect, the invention comprises a method for managing a networked community comprising: establishing behavioral criteria for said networked community; evaluating a behavior of one of a plurality of cyberidentities in said networked community based at least in part on said established behavioral criteria; imposing a penalty on said one of a plurality of cyberidentities in said networked community based at least upon said evaluation of said behavior.

### CROSS REFERENCE TO RELATED APPLICATIONS

This application claims priority to U.S. Provisional Patent Application No. 60/860,342, filed Nov. 21, 2006, the entire contents of which are incorporated herein by reference.

### BACKGROUND AND SUMMARY

Early personal computers (PCs) were used as standalone computing devices. Later PCs were connected via networks, which allowed one computer to communicate with another. For example, and as recognized by those of ordinary skill in the art, Local Area Networks (LAN) and Wide Area Networks (WAN) allowed a plurality of computers to communicate with each other despite a lack of physical proximity.

### Communities

Physical communities are communities consisting of individuals who use traditional methods to communicate. Physical communities can be categorized based the communications mechanism used to establish the community, e.g., newspapers, personal conversation, mail, television, telephone, public speaking, etc.

A networked computer community is generally considered to consist of individuals who use networked computers to communicate. These individuals typically have some common characteristics or shared interest and use the networked computer community to communicate with other individuals in the community. Networked computer communities can be based on various communication methods, including by way of example only, public message posting (e.g., bulletin boards, blogs, forums), targeted non-real-time communication (e.g., e-mail), and targeted real-time communications (e.g., chats or instant messaging).

Early networked computer communities were typically built around mainframe computer networks at universities. In these types of networked computer communities, users could communicate via interconnected computer terminals. The Well was an early PC based networked community. A Bulletin Board Services (BBS) was another networked computer community that allowed users to post messages and files for other users to read or download. Other networked computer communities have also developed, including those based on Internet Relay Chat (IRC), email, blogs, and various other real-time messaging services.

Some examples of different networked computer communities based on various communications mechanisms are shown in FIG. 1. As shown in FIG. 1, content posting, BBS and blogs are typically targeted at all users of a network, or all members of a particular networked computer community. That is, any user or cyberidentity may connect and view the content. As further shown in FIG. 1, e-mail, personal chats, and chat rooms are targeted at particular users or cyberidentities. That is, only those members of a networked computer community that have been “selected” are included in the dissemination of the communication or information. As noted below, any such content may be logged for purposes of radical transparency.

### Community Trust

One important aspect of any community is trust. Trust is the belief of one community individual that another identifiable community individual's future behavior will be predictable. One requirement to establish trust in a community is establishing identity.

In physical communities, identity is determined primarily by physical appearance, e.g., facial features. Individuals in physical communities typically build high-trust relationships over time based on physical interaction. Interaction with a stranger or new acquaintance is inherently low-trust since there has been no physical interaction over time. Interaction with a friend of a friend is an example of an intermediate-trust relationship based on a transfer of trust from one individual to another. Interaction with a stranger whose behavior has been observed over time might also be an intermediate-trust relationship since one individual can infer future behavior of another individual based on past behavior.

An example of the development of a trust relationship is shown in FIG. 2. As shown in FIG. 2, an individual may have a history of behavior known to the community or to a particular member of the community (202). This history can be communicated to other members of the physical community (204), which may result, to some degree, in transferred trust based on prior behavior. The individual's past behavior(s) result in a present perception of the individual, e.g., their reputation (206). This reputation provides a level of trust to members of the community that the individual's future behavior(s) will comport with their past behavior(s) (208). Based on this trust, members of the community may choose to interact with an individual (210). If such interaction is “successful,” the individual will develop a relationship (212), which will serve as another historical behavior known to the community. Continued interactions over time may create an even higher level of trust for that individual, thus serving as the basis for high-trust relationships.

As will be recognized by those of ordinary skill in the art, and as shown in FIG. 3, various societal elements in high- or low-trust societies manifest themselves differently. In particular, and as shown in FIG. 3, a high-trust society may have only a few restrictions on the press (Press Restrictions), whereas a low-trust society may have many restrictions in place. Also, in a high-trust society, there is a strong reliance on the rules (i.e., the “laws” in place), versus a weak reliance on the “laws” in a low-trust society. Further, in a high-trust society, individuals are rewarded and advance in status based on merit rather than on favoritism, bias, or partisanship, e.g., nepotism, tribalism, or group association. In a high-trust society, openness serves as a foundation of interaction between individuals, whereas privacy is paramount is a low-trust society.

In physical communities, people tend to mitigate their behavior due to adverse repercussion such as fear of humiliation, community shunning, or even physical assault. This type of mitigation is often not present in networked computer communities. Further, body language is an important component of interpersonal communications that is missing with networked communications. As a result, the behavior of networked individuals is often less controlled or gracious than behavior in the physical world.

In networked computer communities, trust relationships can be established by transferring them from a physical community (e.g., I'm John Smith your neighbor. My email is . . . ), by interaction with an individual via a networked computer community over time, or by observing network communications behavior with other community members over time. However, in networked computer communities, identity is not a function of unique physical characteristics. Rather identity is something most often chosen by the individual, such as screen name, email address, or some other distinctive identifier. Thus, trust is difficult to establish in networked computer communities because identity is typically difficult to establish or verify. As will be recognized, various forms of identity theft or fraud prevent many networked computer communities from evolving or developing into high-trust societies. Additionally, some networked communities have become havens for criminal activity based on identity fraud.

Two common problems of networked computer communities are sexual predators and pornographers. The presence of sexual predators and pornographers in networked computer communities can degrade the user experience, scare away potential commercial advertisers, and severely limit the trust that can be developed. For example, on the Internet a user posing as a 16 year old girl may in fact be a 40 year old man. This use of a networked computer community by sexual predators is prevalent enough that legislation has been proposed to limit Internet access for children under a certain age. Although the mere existence of commercial pornography in a networked computer community may not be a problem per se, flooding an entire networked computer community with pornography to target the small percentage of users who are interested in the pornography is a real issue. It is likely that a large percentage of other users may be annoyed or offended. These types of behaviors can have a chilling effect on establishing trust in a networked computer community.

For example, MySpace is currently a popular networked computer community of user created internet viewable profiles and personal blogs. MySpace asks users to submit personal information such as age and sex; however, MySpace has no way to establish the truthfulness of the submissions. In several instances users have been solicited to join or have been tricked into sexual liaisons with individuals who were not who they alleged to be. Several users have been murdered. In response, some networked computer communities try to limit individual user's exposure by requiring the user to invite other users to communicate with them. But even this will not prevent a user from falsifying their identity.

Existing solutions fall into four broad categories; trusted editing, user rating, automated filtering, and legislation. In a trusted editing environment information is shared between users of a networked computer community but all information is reviewed and verified by an appointed trusted editor. In this way users can have a certain degree of trust in the information. However, the trusted editor solution poses two problems; who do you trust to be an editor, and how can enough trusted editors be located to allow the system to scale to a very large size? For example, Wikipedia is an Internet encyclopedia of knowledge completely provided by members of the networked computer community. Any user may submit knowledge to the encyclopedia, and any user may delete another user's submissions. A trusted editor oversees information submitted to ensure accuracy.

Another example is YouTube, a video distribution system of user submitted content. Not only does this type of networked computer community suffer from trust issues as noted above, these types of distributions systems often have problems with importation and distribution of copyrighted content and pornography. YouTube claims to have a bank of editors to review new submissions, but with more than 60,000 new submissions each day, scaling the editor staff to the size of the content library is impractical.

User rating attempts to establish an intermediate-trust relationship between virtual strangers. For example, where an individual user has been evaluated (i.e., rated) positively by a number of community members, other members with no prior interaction with that user may feel that user is more trustworthy, i.e., that their behavior will be consistent with their prior interactions with other members. A number of problems exist with this method, including clans of members that boost their own ratings in order to perpetrate fraud, members who intentionally build good ratings to later perpetrate fraud, members who are singled out by the community to damage their ratings, and users continually establishing new identities when their rating is unfavorable.

Automated filtering is a technology challenge that has proven to be a tremendous technical challenge due to the complex and often ambiguous nature of filtering languages, e.g., English. One significant drawback is over-filtering. That is, blanket rejections based on keywords may block relevant and unobjectionable content

Legislation has been almost totally ineffective, due to technical, jurisdictional, enforcement, and numerous other problems. Further, Congress is often unable to keep up with technological advances and may lag behind in terms of needed legislation or may enact statutes addressing a problem long after the problem manifests itself.

In one aspect, the invention comprises a system for a networked community comprising: a verification component operable to verify each of a plurality of cyberidentities, a first computer memory operable to store information related to the interaction of each of said plurality of cyberidentities within said networked community; and a transparency component operable to allow said plurality of cyberidentities to access at least part of said stored information.

In various embodiments: (1) said information comprises at least one of: data related to cyberidentity behavior, data related to cyberidentity reputation, data related cyberidentity published content, data related to cyberidentity buddies, and data related to cyberidentity cyberjustice; and (2) the system further comprises a search component operable to search said stored information.

In another aspect, the invention comprises a system for a networked community comprising: a verification component operable to verify each of a plurality of cyberidentities; a computer memory operable to store information related to the interaction of each of said plurality of cyberidentities within said networked community; and an evaluation component operable to evaluate said stored information and provide a trust value for each one of said plurality of cyberidentities based on specified evaluation criteria.

In various embodiments: (1) said information comprises at least one of: data related to cyberidentity behavior, data related to cyberidentity reputation, data related cyberidentity published content, data related to cyberidentity buddies, and data related to cyberidentity cyberjustice; (2) said specified evaluation criteria includes at least one of: type and amount of content published by a cyberidentity; key words and phrases associated with said published content; number and contents of comments received on said published content; number and contents of comments by a cyberidentity, number and cyberidentity of buddies, number of complaints filed by said cyberidentity, number of complaints received against said cyberidentity, and cyberjustice participation; (3) the system further comprises a transparency component operable to allow said plurality of cyberidentities to access at least part of said stored information; and (4) the system further comprises a search component operable to search said stored information.

In another aspect, the invention comprises a method for networked community transparency comprising: verifying each of a plurality of cyberidentities; storing information related to the interaction of each of said plurality of cyberidentities within said networked community; and allowing said plurality of cyberidentities to access at least a part of said stored information.

In various embodiments: (1) said information comprises at least one of: data related to cyberidentity behavior, data related to cyberidentity reputation, data related cyberidentity published content, data related to cyberidentity buddies, and data related to cyberidentity cyberjustice; and (2) the method further comprises a search component operable to allow search said stored information.

In another aspect, the invention comprises a method for establishing a cyberidentity trust value comprising: verifying each of a plurality of cyberidentities; storing information related to the interaction of each of said plurality of cyberidentities within a networked community; and evaluating said stored information and providing a trust value for each one of said plurality of cyberidentities based on specified evaluation criteria.

In various embodiments: (1) said information comprises at least one of: data related to cyberidentity behavior, data related to cyberidentity reputation, data related cyberidentity published content, data related to cyberidentity buddies, and data related to cyberidentity cyberjustice; (2) said specified evaluation criteria comprises at least one of: type and amount of content published by a cyberidentity; key words and phrases associated with said published content; number and contents of comments received on said published content; number and contents of comments by a cyberidentity, number and cyberidentity of buddies, number of complaints filed by said cyberidentity, number of complaints received against said cyberidentity, and cyberjustice participation; and (3) the method further comprises the step of: allowing said plurality of cyberidentities to access at least a part of said stored information.

In another aspect, the invention comprises a method for managing a networked community comprising: establishing behavioral criteria for said networked community; evaluating a behavior of one of a plurality of cyberidentities in said networked community based at least in part on said established behavioral criteria; imposing a penalty on said one of a plurality of cyberidentities in said networked community based at least upon said evaluation of said behavior.

In various embodiments: (1) the method further comprises the step of storing the results of said evaluation and said penalty; (2) the method further comprises the step of allowing said plurality of cyberidentities to access results of said evaluation and said penalty; (3) said penalty comprises limiting access to said networked community; (4) said penalty comprises removal of said cyberidentity from said networked community; (5) said evaluating step comprises selecting a pool of cyberidentities to act as cyberjurors and presenting said behavior of said one of a plurality of cyberidentities to said cyberjurors; and (6) said cyberjurors evaluate compliance of said behavior with said established behavioral criteria.

In another aspect, the invention comprises a method for managing a networked community comprising: verifying each of a plurality of cyberidentities; storing information related to the interaction of each of said plurality of cyberidentities within said networked community, wherein said stored information comprises, at least, behaviors of said cyberidentities within said networked community; evaluating at least one of said behaviors of at least one of said plurality of cyberidentities based at least in part on specified behavioral criteria; and imposing a penalty on said one of said plurality of cyberidentities based at least upon said evaluation of said behavior.

In various embodiments: (1) the method further comprises the step of storing the results of said evaluation and said penalty; and (2) the method further comprises the step of: allowing said plurality of cyberidentities to access said imposed penalty.

### BRIEF DESCRIPTION OF THE DRAWINGS

FIG. 1 depicts various types of networked community communications;

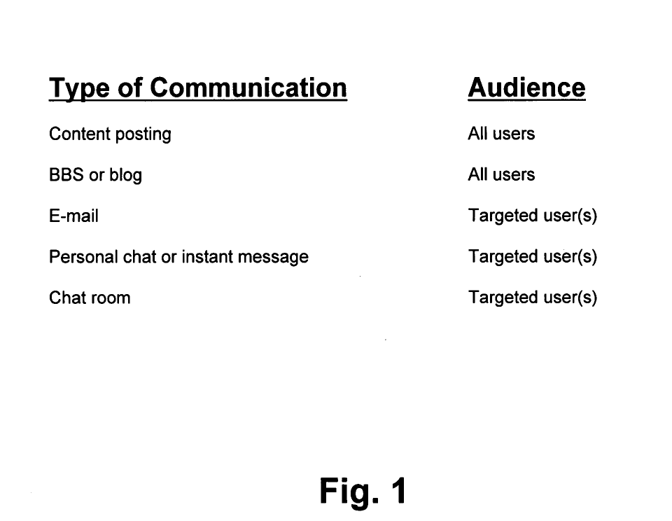

FIG. 2 depicts development of relationships in a networked community;

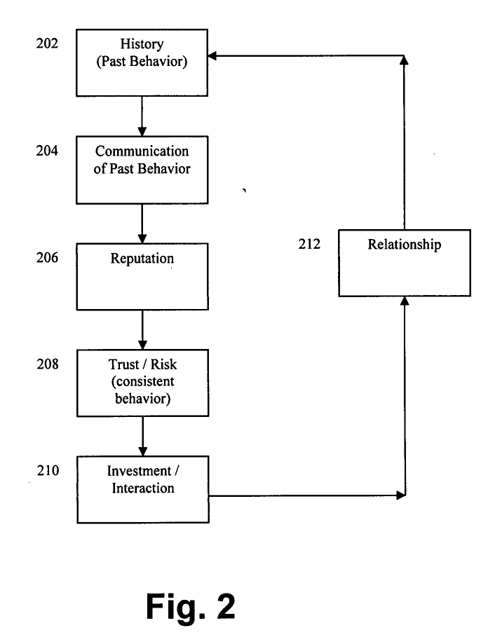

FIG. 3 depicts a comparison between low-trust and high-trust societies;

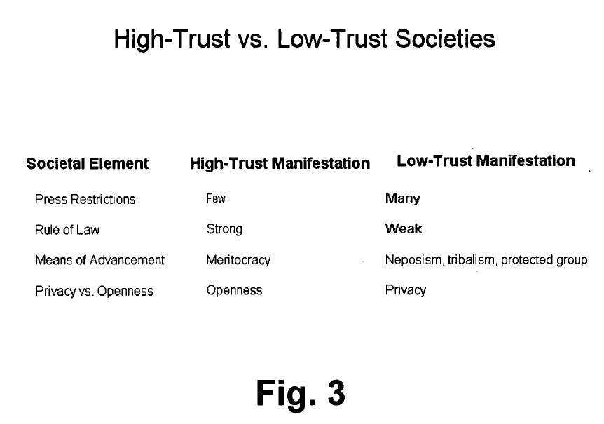

FIG. 4 depicts the relationship between cyberidentity and physical identity;

FIG. 5 depicts networked community communications mechanisms and associated transparency; and

FIG. 6 is a cyberjustice state diagram.

### DETAILED DESCRIPTION

The invention and the embodiments disclosed herein address, inter alia, the two previously discussed networked community problems, identity and behavior, by increasing visibility into networked community behavior, and by implementing a method to police user interactions and behaviors. Although the embodiments disclosed may be directed to networked computer communities, those of ordinary skill in the art will recognize that any devices that are interconnected or networked can implement the described innovations to create networked communities. By way of example only, interconnected or networked PDAs, cellular telephones, Blackberry's, etc., can implement the disclosed innovations.

Even with sophisticated physical identification techniques, e.g. biometric logging, establishing a physical identity in networked communities is exceedingly difficult and prone to fraud. Establishing a cyberidentity, on the other hand, is more probable. A cyberidentity is an identity that corresponds to a particular user in a networked computer community. A cyberidentity can be represented by one, or a combination of, screen name, email address, or other distinctive identifier. A cyberidentity does not necessarily have a one-to-one relationship with a physical identity. In one embodiment, a single physical individual (user) may have multiple cyberidentities, one for each networked computer community the user is participating in. In another embodiment, a single user may have more than one cyberidentity for a single networked computer community.

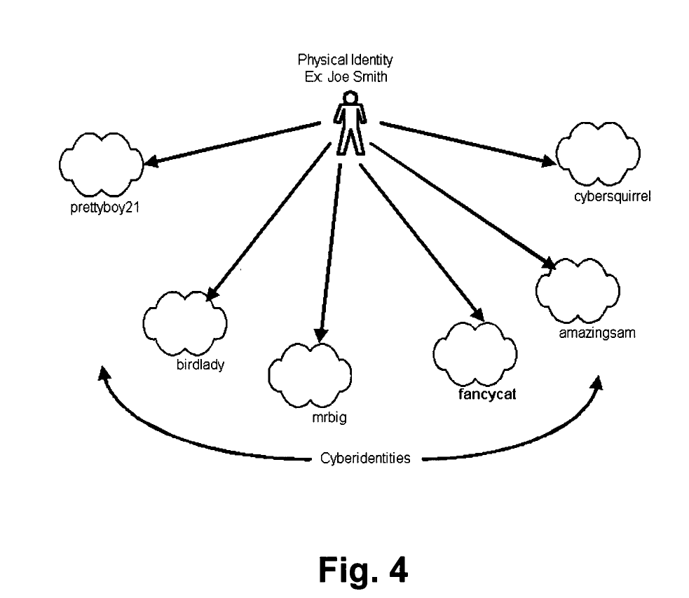

In one embodiment, and as seen in FIG. 4, a physical user may have a plurality of cyberidentities, which may be associated with one or more networked computer communities. Each cyberidentity for the particular networked computer community is associated with the user. In one embodiment, each of the cyberidentities may be cross-referenced to the user and may benefit from trust associated with any other cyberidentities, whether related to the same networked computer community or not. In this embodiment, multiple cyberidentities of an individual are correlated such that the actions of that individual across any number of networked computer communities, or networked computer community cyberidentities, can be used to establish or reject a trust relationship.

In another embodiment, each cyberidentity is independent of the other cyberidentities, thereby developing independent trust relationships apart from any other cyberidentity for a particular user. In this embodiment, independent trust is not imported to other cyberidentities. For example, in one embodiment, when a cyberidentity has been established in a particular networked computer community, the behavior and history of that cyberidentity is kept independent of any other cyberidentity for that user. In this way, one cyberidentity cannot affect the trust or reputation of another cyberidentity. In another embodiment, the present systems and methods are adapted to allow cross-referencing between multiple cyberidentities for one user in a particular networked computer community, but not between multiple networked computer communities. In yet another embodiment, although no correlation is viewable by other users or cyberidentities, the methods and systems can be adapted to allow correlation for purposes of cyberjustice (as described below).

For example, a user may belong to an animal related networked computer community and wish to participate with respect to three different specialties, thus establishing three different cyberidentities in a single networked computer community: birdlady, fancycat, and cybersquirrel. Depending on the embodiment practiced, the reputation of a particular cyberidentity may or may not correlate back to the user. By way of further example, the user may participate in multiple networked computer communities, each with independent cyberidentities. Thus, as described above, each cyberidentity may cross-reference to the user, thereby importing trust associated with other cyberidentities, or each unique cyberidentity may be completely independent of any other cyberidentities for that user.

### Establishing a Cyberidentity

In one embodiment, a first trusted cyberidentity for a user can be established by storing a distinctive electronic identifier and a password on a networked computer system. For example, an identity server may store relevant cyberidentity information for that user. As will be recognized by those of ordinary skill in the art, user information, cyberidentities, trust values, etc., are preferably stored in non-volatile memory, for example hard drives, tape drives, flash drives, etc. Such in formation can be stored on one device, multiple devices, or in separate locations on the same device. Various implementations of localized or networked storage systems are well known in the art.

As will be further recognized by those of ordinary skill in the art, the identity server can be adapted to implement either correlated or independent cyberidentities. That is, the identity server can be adapted to cross reference any number of cyberidentities for a particular user, or can be adapted to keep all cyberidentities independent of other cyberidentities.

As will be recognized by those of ordinary skill in the art, various secure account creation and login mechanisms exist and can be implemented with the present systems and methods. An exemplary secure account creation and login method is described blow. In one embodiment a cyberidentity creation process can include the following steps:

1. A user's computer (or other device) contacts the identity server via any suitable connection method and transmits a distinctive electronic identifier, e.g., a desired screen name.

2. If the distinctive identifier is unavailable or already in use by another user in the networked computer community, the identity server responds with a message indicating that a different distinctive identifier should be chosen.

3. When a distinctive identifier is accepted by the identity server, the identity server creates a unique and random password for that identifier, stores the password in association with the distinctive identifier, and transmits an encrypted version of the password to the user's computer. This password can then be decrypted by the user computer, or can be used as encrypted. Alternately, the password can be generated by the identity server based on any number of unique characteristics of the user's computer, such as CPU serial number, MAC ID, IP address, operating system characteristics, etc. In certain embodiments, a unique algorithm is generated to be used in the authentication process based on any number of unique characteristics of the user's computer. As will be recognized by those of skill in the art, various hashing algorithms can be used to create unique checksum values based on any number of parameters relating to a user computer in addition to the password. For example, variations of SHA, MDx, and CRC can be used to create unique hash values for any number of parameters or values to confirm distinctive identifier identity.

4. The user's computer also stores the identity server's generated password in association with the selected screen name.

In one embodiment, a subsequent identity confirming log in process may include the following steps:

1. The user's computer (or other device) contacts the identity server via any suitable connection method and transmits the stored distinctive identifier, e.g., a screen name.

2. The identity server looks up the screen name and retrieves the associated password.

3. The identity server then generates a unique random key for use in the authentication process.

4. The identity server uses the random key to modify the associated password and create a unique checksum value.

5. The identity server sends random key to the user's computer.

6. The user's computer uses the random key to modify the password stored locally associated with the distinctive identifier to create a unique checksum value.

7. The user's computer sends the checksum value to the identity server.

8. The identity server compares the submitted checksum value with the checksum value it created.

9. If the modified passwords match, the identity of the user's computer is confirmed, and the identity server allows the user's computer to access the networked community.

In another embodiment, a unique algorithm, as described above, is used to modify the password stored in the identity server to create a unique checksum value. The user computer is then instructed to use the same algorithm to generate a unique checksum value based on information stored or related to the user computer. For example, in various embodiments, this value can be based on the password stored on the user computer, based on any number of unique characteristics of the user's computer, or based on any combination of password(s), characteristics, or the like. As described above, this password may be stored on the user computer. If the identity server verifies that the two checksum values match, user's computer is granted access to the networked computer community. As noted above, various hashing methods can also be used to create unique checksum values based on any number of parameters, including characteristics relating to a user computer, password(s), etc.

As will be recognized by those of ordinary skill in the art, the above described steps provide additional security advantages such as securely storing unique identity elements (e.g., distinctive identifier and password) on a specific computer, preventing dissemination of user e-mail or other user information, and ensuring passwords are never transmitted in an unencrypted form across any network connection.

Radical Transparency

As noted in the above described embodiments, there is not necessarily a transferred correspondence between a networked computer community identity and a physical user identity. That is, there may be no importation of known physical user reputation with respect to a particular networked computer community identity. Therefore trust in a networked computer community may need to be established by observing networked community behavior over a period of time. One approach to such networked community behavior is called radical transparency. Radical transparency is a social behavior theory that proposes to predict the behavior of individuals in a community whose primary feature is the ability of one individual to observe both the present and historical behavior of every other individual.

Radical transparency implies that any user in the community may see all the current and historical communications of any other user, i.e., the user's communications and behaviors are transparent. Each type of communications leaves its own record that may be searched by various means. Searches of the communications records may be used by community members to establish the networked community reputation corresponding to a cyberidentity.

In one embodiment, features of radical transparency are combined with networked community behavior. In this embodiment, the system stores all networked community behavior associated with each user or cyberidentity and makes it available for review by all other users or cyberidentities in the networked community. The history of a particular cyberidentity's networked community behavior may then be used to establish the cyberidentity's reputation within the networked community.

In one embodiment, a networked community of users with equal access to a cyberidentity's reputation within the networked community is provided. In this respect, there are no editors, moderators, etc., with special access to reputation information. Further, all aspects of a particular cyberidentity are available for review, thus the activities of that cyberidentity are transparent.

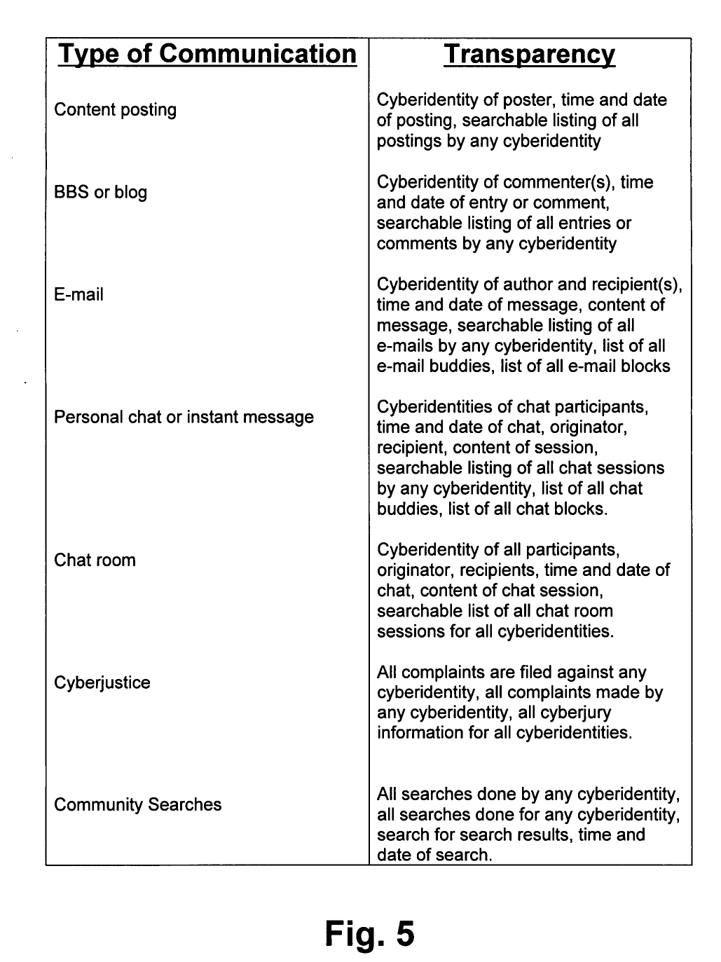

As shown in FIG. 5, traditional communications mechanisms can be combined with radical transparency to provide other users with full access to a particular cyberidentity's behavior. This transparency can be used by other users to determine what level of trust to give to a particular cyberidentity. Alternately, the reputation of a particular cyberidentity can be determined by reviewing that cyberidentity's behavior(s).

In one embodiment, and as shown in FIG. 5, radical transparency can be integrated with content posting. Content posting can be text, graphics, or multimedia content displayed, distributed, or published in such a manner that all users in a networked community may view or retrieve it. In a radical transparency networked community, all of a cyberidentity's content postings are indexed such that history of the cyberidentity's postings may be viewed or retrieved by any other user. Relevant information such as time and date of posting, as well as searchable index of all postings for a particular cyberidentity may be provided.

In another embodiment, and as shown in FIG. 5, radical transparency can be integrated with a blog or BBS. A blog or BBS may be associated with an individual or a piece of text or media content. Each blog or BBS entry may be associated with a particular cyberidentity. Relevant information such as time and date of posting, as well as searchable index of all postings for a particular cyberidentity may be provided. In a radical transparency networked community, a log of all postings is maintained even after the relevant text or content has been removed from the blog and the contents of this log may be read by any user.

Some existing blog or BBS systems require the publisher of the blog to agree to the posting before it can be done. In a radial transparent networked community, the publisher of the blog may be allowed to view or retrieve the communications history of a particular networked community cyberidentity. The communications history may include a log of all requests to post by a cyberidentity and the results of those requests. It may also include a log of all requests to post on a particular cyberidentity's blog and the results of those requests. A publisher of a blog may accept or reject a post request on a one time basis, or on a global basis. In certain embodiments, a publisher of a blog may create a list of “buddies” which provides a list of cyberidentities whose post requests will automatically be granted. Similarly, a list of “blocks” may be created such that certain cyberidentity's post requests will automatically be refused. A publisher of a blog may remove cyberidentities from either the buddies or blocks at any time. Both the buddy and block additions and deletions may be logged with date and time.

In another embodiment, and as shown in FIG. 5, radical transparency can be integrated with e-mail. In a radical transparency networked community, email of any user may be read by any other user. Email logs may retain the message and the cyberidentity of the participants and may be read by any other user. Other relevant information such as time and date of the email, as well as searchable index of all emails for a particular cyberidentity may be provided.

In another embodiment, and as shown in FIG. 5, radical transparency can be integrated with content personal or group chats. In a radical transparency networked community, chats or instant messaging communications by any user may be observed by any other user in real time. Further, all personal chat or instant messaging communications may be logged with time and data and cyberidentity of the participants and may be read by any other user. Further, relevant information such as time and date of chat, as well as searchable index of all chat logs for a particular cyberidentity may be provided.

Some existing personal chat or instant messaging systems require the destination user to agree to the chat before it can begin. In a radial transparent networked community, the destination user may be allowed to view or retrieve the communications history of a particular cyberidentity. The communications history may include a log of all chats requested by this cyberidentity and the results of those requests. It may also include a log of all chats requested on this cyberidentity and the results of those requests.

A user may accept or reject a chat request on a one time basis or on a global basis. In certain embodiments, a user may create a list of “buddies” which provides a list of cyberidentities whose chat requests will automatically be accepted. Similarly, a list of “blocks” may be created such that certain cyberidentities chat requests will automatically be refused. A user may remove cyberidentities from either the buddies or blocks at any time. Both the buddy and block additions and deletions may be logged with date and time.

In another embodiment, and as shown in FIG. 5, radical transparency can be integrated with chat rooms. In a radical transparency networked community, chats room communications by any user may be observed by any other user in real time. Further, all chat room communications may be logged with time and data and cyberidentity of the participants and may be read by any other user. Further, relevant information such as time and date of chat, as well as searchable index of all chat logs for a particular cyberidentity may be provided.

Other embodiments illustrated in FIG. 5, e.g., cyberjustice and community searches, are described in detail below.

### Searching

As will be recognized by those of ordinary skill in the art, networked computer community communications logs can be an effective representation of networked computer community reputation when organized by a retrieval system. Additionally, searches and search results are also logged and are made available to all users. As will be recognized by those of ordinary skill in the art, in radical transparency, both the search and results are logged, as well as the cyberidentity performing the search. The following are examples of user communications searches:

### Searching a Specific Cyberidentity

Search for all content published by a cyberidentity.
Search for all comments on a particular piece of published content by a specific cyberidentity, sorted chronologically.
Search for the indexed words and phrases of this user's published content, sorted by frequency of use.
Search for the words and phrases used to search other user's published content, sorted by frequency of use.
Search for all comments on any blog content by a specific cyberidentity, sorted chronologically.
Inspect the chat destinations for a cyberidentity, sorted by frequency of chat.
Inspect the chat requests for a cyberidentity, sorted by frequency of request.
Inspect the buddy list for a cyberidentity, sorted chronologically.
Inspect the block list for a cyberidentity, sorted chronologically.
Inspect all communications for a cyberidentity, sorted chronologically.

### As will be recognized by those of ordinary skill in the art, any sort parameters can be implemented for any search performed.

### Searching Across the Entire Networked Community

Search for all cyberidentities who published content, sorted by most content.
Search for the indexed words and phrases of all published content, sorted by frequency of use.
Search for the words and phrases submitted for published content search, sorted by frequency of use.
Search for all eMail messages containing a word or phrase, sorted chronologically.
Search for all cyberidentities who received comments on their published content, sorted by most comments.
Search for all cyberidentities who posted comments on content, sorted by most comments
Search for all cyberidentities who searched other cyberidentities, sorted by frequency of use.
Search for all cyberidentities who were buddies with other cyberidentities, sorted by most buddies.
Search for all cyberidentities who blocked other cyberidentities, sorted by most blocks.

### As will be recognized by those of ordinary skill in the art, any sort parameters can be implemented for any search performed.

### Reputation and Trust

Individuals in the physical world seek approval, seek socialization, and seek to avoid embarrassment. Similar motivations drive users in a networked community. In a networked community, communications between users equate to the socialization mechanisms. As described above, typical communication methods include content posting, BBS or blogs, e-mail, personal chats or text messaging, and chat rooms. Users, and more particularly a cyberidentity, elect to interact via one or more mechanism. During the course of any interaction, a reputation for that cyberidentity is developed. Each user spends time and energy to develop a positive reputation and will typically seek to avoid embarrassment or behave in such a manor as to damage their reputation.

In one embodiment, a networked user may choose who to socialize or not socialize with by maintaining a list of “buddies” (those with whom communication is automatically accepted) or a list of “blocks” (those with whom communication is automatically denied). As will be recognized by those of ordinary skill in the art, a user or cyberidentity may be accepted as a buddy by another user or cyberidentity with whom the first user or cyberidentity has a preexisting relationship. In another embodiment, a user or cyberidentity may be accepted as a “buddy” if the user's (or cyberidentity's) reputation is deemed suitable to be added as a buddy.

In certain embodiments a user's or cyberidentity's reputation is based on one or more of the following:
type and amount of content published,
key words and phrases associated with published content,
number and contents of comments posted,
number and contents of comments received on published content,
number and cyberidentity of buddies,
number and cyberidentity of blocks,
content of previous chat conversation,
number of complaints filed (described in detail below),
number of complaints received (described in detail below),
jury participation (described in detail below).

Therefore, in certain embodiments, in order to participate in the networked community or to be an accepted member of a particular networked computer community, a user may need to have, or may be required to maintain, a favorable reputation.

In the embodiments described above, there are many effects of radical transparency. The following are examples of the effects of radical transparency on a community of networked users:
Publishing, searching for, and downloading of pornography will be substantially restricted to a community of similar interests. In one embodiment, the system and methods described are adapted to allow a user to maintain two discrete and disconnected cyberidentities, e.g., Mr. Hyde for searching pornography, and Dr. Jekyll for interacting with a stamp collecting group. That is, neither cyberidentity relates back to or incorporates the reputation of the other or of the user. Thus, since radical transparency makes visible all search behavior, only similarly inclined cyberidentities will chose to interact with the Mr. Hyde identity. As will be recognized, even if the Mr. Hyde and Dr. Jekyll cyberidentities represent the same user, Dr. Jekyll will be unlikely to share his Mr. Hyde personality with other users for fear of losing community contact through or reputation of the Mr. Hyde cyberidentity. Any overlap between the Dr. Jekyll and Mr. Hyde cyberidentities may result in ostracism of the Dr. Jekyll cyberidentity in certain preferred networked computer communities.
Although predatory behavior may continue to exist in the presence of radical transparency, all users will have access to the information necessary to avoid it. In certain embodiments, as described in detail below, various behaviors, e.g., predatory behavior, may subject a cyberidentity to removal through networked community justice, or may subject a user to removal of all cyberidentities.
In networked computer communities, users are often less polite than they would be in person. With radical transparency, users behavior would more closely mimic physical interaction, and in some cases users may be more polite than in person due to potential negative reputation.
The embodiments disclosed will improve the overall behavior in a networked computer community due to the deterrent effect of negative reputation, embarrassment, possible shunning, or removal.
Dr. Jekyll and Mr. Hyde individuals may attempt to entice other users to communicate using mechanisms not subject to radical transparency, and thereby exposing the enticed user to risks found in traditional networked communities. This trickery would be documented in various radical transparency logs and would most likely be detected by other users. This could detract for the cyberidentity's reputation, and could subject the cyberidentity to cyberjustice (described below).

As recognized by those of ordinary skill in the art, a user or cyberidentity may have many points of reference that can serve as a basis to determine their reputation. Some users may not wish to independently evaluate every communication for a cyberidentity in order to assess their reputation. Further, many points of reference may be irrelevant to a particular user. For example, the number of blog entries may not shed any light on trustworthiness with respect to financial matters.

In one embodiment, the systems and methods disclosed may be adapted to evaluate the reputation of a particular cyberidentity or user and calculate a trust value. In another embodiment, the present systems and methods are adapted to enable the system and/or individual users or cyberidentities to dictate relevant criteria to determine a trust value. As will be recognized by those of ordinary skill in the art, a trust value can be determined on a one time basis or can represent an overall trust level for a cyberidentity or user. In one embodiment, the trust value can be a numerical representation of a particular user's or cyberidentity's reputation. In another embodiment, a trust value can be a graphical representation, e.g., a red light or a green light; or a thumbs-up or thumbs-down.

In another embodiment, determining a trust value can be accomplished by using a weighted system for each item that serves as a basis for reputation. The system and methods disclosed are also adapted to allow a user to select which factors to include in the determination. Thus, a trust value can be based on any number of factors, including, by way of example only:
type of content published by a cyberidentity;
amount of content published by a user or cyberidentity;
type of content for a user or cyberidentity;
length of membership in a networked computer community;
key words and phrases associated with published content;
number and contents of comments received for published content;
rating of a user or cyberidentity by other members of a networked computer community;
number and contents of comments made by a user or cyberidentity;
number and cyberidentity of buddies;
number and cyberidentity of blocks;
number of cyberidentities for a user;
number of complaints filed by a user or cyberidentity,
number of complaints received against a user or cyber identity,
recency of any complaint;
relationship between any complaint and a particular networked computer community; and
cyberjustice participation.

As will be further recognized by those of ordinary skill in the art, various factors may be weighted differently in determining a trust value. For example, being sanctioned for predatory behavior may be weighted differently than only have one content posting. Any suitable weighting system or method can be implemented as appropriate for a particular community.

### Cyberjustice

Cyberjustice is a method to manage networked community behavior that may be implemented instead of, in addition to, or as a supplement to radical transparency. As described above radical transparency seeks to encourage “good” behavior to improve reputation. Cyberjustice can be used to modify a user's or cyberidentity's behavior to comply with networked community standards or can be used to punish a particular cyberidentity or user, e.g., restricting access to a particular community temporarily or permanently.

An exemplary set of rules and consequences is provided below that can be implemented to govern a networked computer community. As will be recognized by those of ordinary skill in the art, many variations of these rules and consequences can be implemented as necessary for a particular community, the nature of the networked computer community, or based on the severity of the offense. For example:

1. The Community Allows No Posting or Distribution of Child Pornography.
First offense—the guilty cyberidentity is permanently prevented from communicating in a networked community.
Alternate—the user and all cyberidentities are permanently prevented from communicating in all networked communities.

2. The Community Allows No Personal (Ad Hominem) Attacks.
First offense—the guilty cyberidentity is prevented from communicating in the networked community for 1 day.
Second offense—the guilty cyberidentity is prevented from communicating in the networked community for 7 days.
Second offense alternate—the user and all cyberidentities are prevented from communicating in any networked community for 7 days
Third offense—the guilty cyberidentity is permanently prevented from communicating in the networked community.
Third offense alternate—the user and all cyberidentities are permanently prevented from communicating in all networked communities.

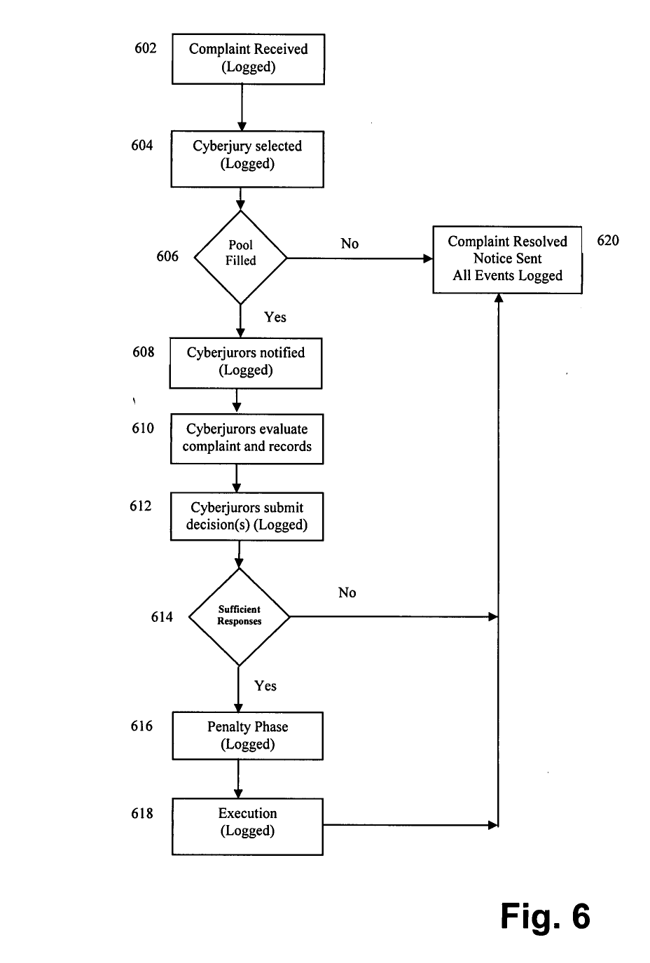

A state diagram for one embodiment of a cyberjustice system is shown in FIG. 6.

As shown, a user may file a networked community complaint to a justice server (602). In one embodiment the complaint contains: the cyberidentity of the complainant, the cyberidentity of the complainee, the rule allegedly violated, and a short text description of why the complainee's networked community behavior violated the rule. In embodiments implementing radical transparency links to examples of the alleged violation may be included.

In step 604, after the complaint is received, the justice server selects a number of current network community users to potentially serve on a cyberjury. In a preferred embodiment, one hundred cyberjurors are randomly selected to participate (604). In one embodiment, the potential cyberjurors are selected from currently connected users. In another embodiment the potential cyberjurors are selected from all members of a particular networked computer community. In yet another embodiment, the potential cyberjurors are selected from all members of all networked computer communities. In one embodiment, if the justice server is unable to locate a predetermined number of potential cyberjurors (606), the complaint may be dismissed and the complainant and complainee are notified of this result (620). In another embodiment, if the justice server is unable to locate a predetermined number of potential cyberjurors, the complainant and/or complainee may be contacted to agree to a smaller potential cyberjury pool. In yet another embodiment, the cyberjustice servers continues with the currently allocated cyberjury pool.

Each potential cyberjuror selected receives an electronic notice of being chosen for a cyberjury which may also contain links to the details of the complaint and relevant examples of the alleged violation (608).

The selected potential cyberjurors may have a predetermined amount of time to research the case, deliberate, and render a decision (610). For embodiments implementing currently connected cyberidentities, a shorter time for submission of decisions may be appropriate, e.g., one hour. For embodiments implementing both connected and unconnected cyberidentities, twenty-four hours may be appropriate. As will be recognized by those of ordinary skill in the art, these parameters can be varied without departing from the spirit of the disclosed embodiments.

When a juror reaches a decision, that cyberjuror submits the decision to the justice server. In a preferred embodiment, the first twelve cyberjurors to respond render a verdict polling complete (612). In another embodiment, polling is complete after a particular time has expired. In yet another embodiment, polling is complete when all cyberjurors have submitted a verdict. In yet another embodiment, any desired number of cyberjuror decisions can be included in a verdict tally. When polling is complete, the justice server tallies the verdicts. In one embodiment, a decision that could ban a cyberidentity or a user must be unanimous. In other embodiments, a majority or supermajority decision can be used to determine sanctions. In one embodiment, where insufficient numbers of cyberjurors respond to the allegations, the complaint may be dismissed (614) and the complainant and complainee are notified of this result (620).

In a preferred embodiment, after the justice server determines a verdict, the server enters the penalty phase of cyberjustice (616). In one embodiment, various offenses and penalties are stored in a database. In another embodiment, penalties are included in the polling request to each cyberjuror. As will be recognized by those of ordinary skill in the art, various implementations of offenses and penalties are contemplated and can be provided by any suitable method without departing from the spirit of the disclosed embodiments. When the appropriate penalty is determined, the justice server executes the sanction (618). The complainer and complainee are electronically notified of any outcome (620).

As shown in FIG. 6, all actions by the cyberjustice system are also logged and associated with the relevant cyberidentities. Such actions include, but are not limited to:
filing a complaint,
being complained against,
being chosen for cyberjury,
rendering (or failing to render) a decision as a cyberjuror,
rendering one of the decisions tallied by the justice server,
how a user voted.

In one embodiment, the implementation of rules and consequences is determined by votes of the cyberidentities in a particular networked computer community. The voting member may be chosen at random from the networked community. In another embodiment, the implementation of rules and consequences is determined by the entity responsible for the networked computer community. In yet another embodiment, the implementation of rules and consequences is determined by a standards body for a particular networked computer community. In yet another embodiment, the implementation of rules and consequences is determined by periodic meetings of the cyberidentities in a particular networked computer community. As will be recognized by those of ordinary skill in the art, any suitable method may be used to implement rules and consequences in any networked computer community.

### Scalability

A significant advantage of the innovations disclosed is scalability. Every user or cyberidentity can be a censor, policeman, traffic cop and juror. As more users and cyberidentities are added, more are available for the networked community policing functions. A second advantage is fairness. Large networked communities such as Wikipedia, depend on editors to determine what is acceptable and what is not. Users often wonder; who selects the editors, is the editor biased, and how can I be an editor?

By letting users and/or cyberidentities manage a networked computer community, a sense of fairness is preserved. Also community standards may change over time. Thus, by allowing users the choice of association with a networked computer community, and when necessary enforcing judgments handed down by randomly picked networked community members, hurt feelings and arguments of bias-common in many networked communities will be minimized.

### Multiple Cyberidentities

As described above, a single user may have multiple cyberidentities. In one embodiment, the systems and methods disclosed are adapted to allow these cyberidentities to have different and discrete networked community histories of communications and therefore different reputations. This embodiment allows different cyberidentities of one user to develop independent reputations for disparate interests without fear of ostracism in one networked computer community. Although this embodiment may allow the Dr. Jekyll and Mr. Hyde scenario presented above, just as with individuals who attempt to entice users away from radical transparency communications, a Dr. Jekyll cyberidentity can only misbehave a limited number of times before being exposed as a Mr. Hyde and be subject to cyberjustice.

In another embodiment, the systems and methods disclosed are adapted to allow these cyberidentities to have linked networked community histories of communications and therefore shared reputations. This embodiment allows the different cyberidentities of one user to benefit from a favorable reputation.

As will be recognized by those of ordinary skill in the art, the systems and methods described can be adapted to allow both independent and shared reputations between any number of identities of a single user. This choice can be user selected, or can be mandated by the system or networked computer community. For example, a user may wish to have five identities that are linked to share reputation, and may also have one or more other discrete cyberidentities that are completely independent of the other cyberidentities. Those of ordinary skill in the art will recognize that any such separation need not be maintained when implementing cyberjustice.

Creating a cyberidentity requires an investment of hard work, similar to establishing a reputation in the physical world. As in the physical world, those who have invested in their reputation will not discard their investment frivolously.

### Applications

Various benefits and applications will be apparent to those of ordinary skill in the art. Thus, the following applications are exemplary only:
On-line vendors may use shill customers to inflate ratings for certain products. Using the above described systems and methods, shilling is more difficult since the opinion of users with better reputations will have a greater affect on potential customers. The investment of time and energy necessary to create a shill cyberidentity with a high reputation prohibits their use for endorsing penny stocks, male enhancement products, and similar fare.
The present systems and methods are adapted to allow commercial clickable messages. Clicking such a link will direct a user or cyberidentity to a commercial entity's web page, and will also log the click. The click log will contain the message clicked, the time and date, and the cyberidentity and associated (encrypted) password that clicked. The presence of the cyberidentity and password in the click information makes fraudulent clicking difficult to hide.
Click fraud perpetrated from web links within the described systems and methods are more difficult to execute than links in standard web pages since the cyberidentity is public, but the associated password is not. Combining the two is very difficult without physical access to the user's computer; shill cyberidentities are easily identified by their lack of other radical transparency information; and rapid clicking on links (a common method of click fraud) will be logged and easily detected.
The present systems and methods provide for a more accurate data logging method for a particular advertisement if combined with a database of user information and data mining. That is, relevant information about a user can be correlated with a particular advertisement to determine effectiveness. Further, advertising can be targeted to a particular pool of cyberidentities based on relevant information in user profiles or other database entries.

It will be appreciated that the present invention has been described by way of example only and with reference to the accompanying drawings, and that improvements and modifications may be made to the invention without departing from the scope or spirit thereof.

What is claimed is:

1. A system for a networked community comprising:
a verification component operable to verify each of a plurality of cyberidentities;
a first computer memory operable to store information related to the interaction of each of said plurality of cyberidentities within said networked community; and
a transparency component operable to allow said plurality of cyberidentities to access at least part of said stored information.

2. The system of claim 1 wherein said information comprises at least one of: data related to cyberidentity behavior, data related to cyberidentity reputation, data related cyberidentity published content, data related to cyberidentity buddies, and data related to cyberidentity cyberjustice.

3. The system of claim 1 further comprising a search component operable to search said stored information.

4. A system for a networked community comprising:
a verification component operable to verify each of a plurality of cyberidentities;
a computer memory operable to store information related to the interaction of each of said plurality of cyberidentities within said networked community; and
an evaluation component operable to evaluate said stored information and provide a trust value for each one of said plurality of cyberidentities based on specified evaluation criteria.

5. The system of claim 4 wherein said information comprises at least one of: data related to cyberidentity behavior, data related to cyberidentity reputation, data related cyberidentity published content, data related to cyberidentity buddies, and data related to cyberidentity cyberjustice.

6. The system of claim 5 wherein said specified evaluation criteria includes at least one of:
type and amount of content published by a cyberidentity;
key words and phrases associated with said published content;
number and contents of comments received on said published content;
number and contents of comments by a cyberidentity,
number and cyberidentity of buddies,
number of complaints filed by said cyberidentity,
number of complaints received against said cyberidentity, and
cyberjustice participation.

7. The system of claim 4 further comprising a transparency component operable to allow said plurality of cyberidentities to access at least part of said stored information.

8. The system of claim 7 further comprising a search component operable to search said stored information.

9. A method for networked community transparency comprising:
verifying each of a plurality of cyberidentities;
storing information related to the interaction of each of said plurality of cyberidentities within said networked community; and
allowing said plurality of cyberidentities to access at least a part of said stored information.

10. The method of claim 9 wherein said information comprises at least one of: data related to cyberidentity behavior, data related to cyberidentity reputation, data related cyberidentity published content, data related to cyberidentity buddies, and data related to cyberidentity cyberjustice.

11. The method of claim 9 further comprising a search component operable to allow search said stored information.

12. A method for establishing a cyberidentity trust value comprising:
verifying each of a plurality of cyberidentities;
storing information related to the interaction of each of said plurality of cyberidentities within a networked community; and
evaluating said stored information and providing a trust value for each one of said plurality of cyberidentities based on specified evaluation criteria.

13. The method of claim 12 wherein said information comprises at least one of: data related to cyberidentity behavior, data related to cyberidentity reputation, data related cyberidentity published content, data related to cyberidentity buddies, and data related to cyberidentity cyberjustice.

14. The method of claim 12 wherein said specified evaluation criteria comprises at least one of:
type and amount of content published by a cyberidentity;
key words and phrases associated with said published content;
number and contents of comments received on said published content;
number and contents of comments by a cyberidentity,
number and cyberidentity of buddies,
number of complaints filed by said cyberidentity,
number of complaints received against said cyberidentity, and
cyberjustice participation.

15. The method of claim 12 further comprising the step of: allowing said plurality of cyberidentities to access at least a part of said stored information.

16. A method for managing a networked community comprising:
establishing behavioral criteria for said networked community;
evaluating a behavior of one of a plurality of cyberidentities in said networked community based at least in part on said established behavioral criteria; and
imposing a penalty on said one of a plurality of cyberidentities in said networked community based at least upon said evaluation of said behavior.

17. The method of claim 16 further comprising the step of storing the results of said evaluation and said penalty.

18. The method of claim 17 further comprising the step of allowing said plurality of cyberidentities to access results of said evaluation and said penalty.

19. The method of claim 16 wherein said penalty comprises limiting access to said networked community.

20. The method of claim 16 wherein said penalty comprises removal of said cyberidentity from said networked community.

21. The method of claim 16 wherein said evaluating step comprises selecting a pool of cyberidentities to act as cyberjurors and presenting said behavior of said one of a plurality of cyberidentities to said cyberjurors.

22. The method of claim 21 wherein said cyberjurors evaluate compliance of said behavior with said established behavioral criteria.

23. A method for managing a networked community comprising:
verifying each of a plurality of cyberidentities;
storing information related to the interaction of each of said plurality of cyberidentities within said networked community, wherein said stored information comprises, at least, behaviors of said cyberidentities within said networked community;
evaluating at least one of said behaviors of at least one of said plurality of cyberidentities based at least in part on specified behavioral criteria; and
imposing a penalty on said one of said plurality of cyberidentities based at least upon said evaluation of said behavior.

24. The method of claim 23 further comprising the step of storing the results of said evaluation and said penalty.

25. The method of claim 24 further comprising the step of: allowing said plurality of cyberidentities to access said imposed penalty.
